(19) United States
(12) Patent Application Publication
(10) Pub. No.: US 2020/0355018 A1
(43) Pub. Date: Nov. 12, 2020

(54) TAMPER PREVENTION SYSTEM AND METHOD FOR REMOTELY MONITORED SEALING AND UNSEALING OF CONTAINERS

(71) Applicant: THE EUROPEAN UNION, REPRESENTED BY THE EUROPEAN COMMISSION, Brussels (BE)

(72) Inventor: Francois Littmann, Cocquio Trevisago (IT)

(73) Assignee: THE EUROPEAN UNION, REPRESENTED BY THE EUROPEAN COMMISSION, Brussels (BE)

(21) Appl. No.: 16/960,390

(22) PCT Filed: Dec. 13, 2018
(86) PCT No.: PCT/EP2018/084751

§ 371 Date: Jul. 7, 2020

(30) Foreign Application Priority Data
Jan. 11, 2018 (EP) 18151217.9

(51) Int. Cl. E05G 1/10; E05G 1/024; E05G 1/08; G21F 9/36

(52) U.S. Cl. CPC E05G 1/10; G21F 9/36; E05G 1/08; E05G 1/024

(57) ABSTRACT

A tamper prevention system comprising a storage unit is described. The storage unit comprises at least one storage compartment for storing a sealing element for containers, and a control system configured for detecting opening of the at least one storage compartment. Each storage compartment comprises a leash element connected to the control system and provided for being connected to a sealing element to be stored in the storage compartment. The control system is configured for monitoring the integrity of the leash element. The tamper prevention system comprises movement protection device configured for detecting and/or preventing movement of the storage unit.

### TECHNICAL FIELD

The present invention relates to a tamper prevention system for use in sealing and unsealing containers, such as dry storage casks for nuclear spent fuel. Furthermore, the present invention also relates to methods for sealing and unsealing containers using the tamper prevention system according to the present invention.

### BACKGROUND ART

With the phasing out of nuclear plants, a lot of nuclear spent fuel will have to be stored in dry storage casks, in Europe and throughout the world. Inspectors of safeguards agencies won't be able to be physically present for the sealing operations needed for all those casks. First, because of the huge costs of manpower and travel, but also because the operators are filling those casks at a random interval depending on the process speed. There is thus a need for systems and methods for sealing storage casks which do not require the physical presence of the inspectors.

Sealing bolts for sealing storage casks are known from EP 3 206 211 A1. Such sealing bolts are provided with communication means via which an identifier and status information of the sealing bolt can be read out remotely. This enables a local operator to install a sealing bolt on a storage cask, while being monitored remotely by an inspector by means of a video surveillance system. While following the installation via the video surveillance system, the inspector can also remotely check the identifier and the status information of the sealing bolt via the communications means. The remote monitoring by means of the video surveillance system does however not fully prevent tampering with the sealing bolt, because the inspector cannot be sure that a sealing bolt identified by him has been installed on the cask seen on the video surveillance system or on a different cask. A different sealing bolt might for example be shown on the video surveillance system, while the sealing bolt identified by the inspector is being installed outside the field of view of the video surveillance system on another storage cask.

A system for preventing tampering with sealing bolts is known from EP 3 205 996 A1. This tamper prevention system comprises an enclosure in which a sealing bolt or other sealing element for casks or containers can be stored. The tamper prevention system is provided such that a vacuum may be applied on the enclosure. An unauthorised opening of the enclosure can then be detected by pressure changes sensed by means of a pressure sensor in the enclosure. This system prevents tampering with the sealing bolt as long as it is stored in the enclosure, but it cannot prevent tampering with the sealing bolt during remote monitoring on a video surveillance system as described above.

### DISCLOSURE OF THE INVENTION

It is an aim of the present invention to provide a tamper prevention system which enables a tamper proof sealing of a container with a sealing element by a local operator which is remotely monitored by an inspector on a video surveillance system.

This aim is achieved according to the invention with a tamper prevention system according to the first independent claim.

Therefore, the present invention provides a tamper prevention system. The tamper prevention system comprises a storage unit. The storage unit comprises at least one storage compartment for storing a sealing element for containers. The at least one storage compartment is arranged for being opened and closed. The storage unit comprises a control system configured for detecting opening of the at least one storage compartment. Each storage compartment comprises a leash element. The leash element is connected to the control system. The leash element is provided for being connected to a sealing element to be stored in the storage compartment. The control system is configured for monitoring the integrity of the leash element. The tamper prevention system comprises movement protection means configured for detecting and/or preventing movement of the storage unit.

With the tamper prevention system of the present invention an inspector can store in advance, at a moment when the inspector is at the location where containers are being sealed, a sealing element with an identifier known to the inspector, in the at least one storage compartment of the storage unit, and connect the sealing element with the leash element in the at least one storage compartment.

The control system being configured for detecting opening of the at least one storage compartment thereby offers the advantage that the at least one compartment cannot be opened without the inspector knowing. Opening of the storage compartment may for example be signalled to the inspector by means of a warning light associated with the at least one storage compartment which is visible from a video surveillance system monitoring the storage unit, or may for example be monitored remotely by the inspector through communication with the control system of the storage unit. This prevents that the sealing element can be taken out of the at least one compartment and tampered with before it is installed on a container.

The leash element offers the advantage that, when the sealing element, connected to the leash element, is taken out of the at least one storage compartment, the movement range of the sealing element around the storage unit is limited by the length of the leash element. This allows the video surveillance system to be positioned such that the sealing element cannot be moved outside of the field of view of the video surveillance system, where the sealing element may be tampered with or where the sealing element may be installed on another container, without the inspector noticing.

The control system being configured for monitoring the integrity of the leash element offers the advantage that the sealing element cannot be disconnected from the leash element without the inspector knowing. Changes in the integrity of the leash element, such as cutting, disconnecting from the control unit or sealing element, may for example be signalled to the inspector by means of a warning light associated with the at least one storage compartment which is visible from a video surveillance system monitoring the storage unit, or may for example be monitored remotely by the inspector through communication with the control system of the storage unit. This prevents that the sealing element with the known identifier can be switched for another sealing element by disconnecting the sealing element with the known identifier from the leash element, and reconnecting the leash element to another sealing element, while the view of the video surveillance system is obstructed, for example by the local operator standing in between the sealing element and the video surveillance system. In this way it becomes impossible to seal another container with the sealing element with the known identifier outside of the field of view of the video surveillance system.

The movement protection means prevents that the storage unit in its entirety can be moved outside the field of view of a video surveillance system, such that tampering with the sealing element may again become possible.

The movement protection means may for example be a large weight integrated in the storage unit, which makes it very difficult to move the storage unit. The movement protection means may for example be a fixing means, such as the sealing bolt of EP 3 206 211 A1, for fixing the storage unit to a surface such as a floor or a wall. The movement protection means may for example be optical tracking means capable of detecting and reporting any movement of the storage unit.

For monitoring the integrity of the leash element, the leash element may comprise a conductor and the control system may comprise a transmitter connected to a first end of said conductor and a detector connected to a second end of said conductor. The control system is then able to monitor the integrity of the leash element based on the modification of a signal transmitted through the conductor from the transmitter to the detector. For connecting the conductor to the transmitter and the detector, there may be provided connectors inside the at least one storage compartment.

Preferably, the conductor comprises an optical fibre, the transmitter comprises an optical transmitter, and the detector comprises an optical detector. The control system is then able to monitor the integrity of the leash element based on the modification of an optical signal passing through the optical fibre. The monitored property of the optical signal may e.g. be its light intensity.

Alternatively, the conductor comprises an electrical cable, the transmitter comprises an electrical transmitter, and the detector comprises an electrical detector. The control system is then able to monitor the integrity of the leash element based on the modification of an electrical signal passing through the electrical cable. The monitored property of the electrical signal may e.g. be its voltage or current.

In an embodiment of the tamper prevention system according to the present invention the leash element has a predetermined length for limiting the movement of the sealing element, when connected to the leash element, within a predetermined region around the storage unit.

The predetermined region around the storage unit in which a sealing element, when connected to the leash element, can be moved, facilitates the installation of a video surveillance system with respect to the storage unit such that the sealing element cannot be moved outside the field of view of the video surveillance system.

The leash element may be arranged such that it has a fixed length. The leash element may also be arranged such that it is stretchable along the longitudinal direction up to at most the predetermined length.

In an embodiment of the tamper prevention system according to the present invention the storage unit is configured for being remotely operated. Preferably, the storage unit is configured to at least enable remote opening and closing of the at least one storage compartment. The tamper prevention system further comprises a remote control unit for remotely operating and monitoring the storage unit. The control system is configured for communication with the remote control unit.

The storage unit being remotely operable and the remote control unit offer the advantage that an inspector has more control over the process of closing and/or opening containers, which decreases the risk of tampering. The remote control unit may for example be used for remotely opening and closing the at least one storage compartment of the storage unit by the inspector, such that the inspector is always sure that the right storage compartment is opened.

This embodiment also enables the inspector to remotely monitor via the control system if the at least one compartment has not been opened without his permission, or if the integrity of the leash element of the at least one storage compartment has not been compromised, or if the leash element of the at least one storage compartment has not been disconnected without his permission.

In an embodiment of the tamper prevention system according to the present invention the control system is configured for communication with a status monitoring system of a sealing element to be stored in the at least one storage compartment. The status monitoring system of the sealing element is configured for monitoring the status of the sealing element, such as an identifier of the sealing element, information about the correct installation of the sealing element on a container, information about the integrity of the sealing element, etc.

The control system being configured for communication with the status monitoring system of the sealing element offers the advantage that the inspector is able to monitor the status of the sealing element remotely via the remote control unit and the control system, which further reduces the risk of tampering with the sealing element.

In an embodiment of the tamper prevention system according to the present invention the control system is configured for secure communication, i.e. authenticated and encrypted, with the remote control unit and/or the status monitoring system of the sealing element to be stored in the at least one storage compartment.

Providing secure communication between the control system and the remote control unit and/or the status monitoring system of the sealing element is beneficial in preventing tampering with the communication sent between the storage unit on the one hand and the remote control unit and/or the status monitoring system on the other hand.

In an embodiment of the tamper prevention system according to the present invention the movement protection means comprises fixing means for fixing the storage unit to a surface. Preferably, the fixing means are tamper proof fixing means which allow for tampering with the fixing means to be detected.

In an embodiment of the tamper prevention system according to the present invention the storage unit is located at a predetermined position. The tamper prevention system further comprises a video surveillance system. The video surveillance system is positioned and oriented such that the storage unit is located within a field of view of the video surveillance system, and such that the leash element of each storage compartment can only be moved within the field of view of the video surveillance system. Preferably, the position and orientation of the video surveillance system is fixed as such. The tamper prevention system comprises a sealing element for containers. The sealing element comprises a status monitoring system configured for monitoring the status of the sealing element. The status of the sealing element may comprise an identifier of the sealing element, information about the installation of the sealing element on a container, information about the integrity of the sealing element, etc.

The present invention further provides a method for sealing a container using the tamper prevention system according to the embodiment of the present invention comprising the video surveillance system. The sealing element is stored in a closed first storage compartment of the storage unit. The sealing element is connected to the leash element of the first storage compartment. The method comprises the step of a local operator positioning the container in the field of view of the video surveillance system. The method comprises the step of a remote operator opening the first storage compartment by means of the remote control unit. In case of sealing containers for nuclear spent fuel, the remote operator is preferably the inspector. The method comprises the step of the local operator taking the sealing element out of the first storage compartment. The method comprises the step of the local operator sealing the container by installing the sealing element on the container. The method comprises the step of the remote operator retrieving via the remote control unit and the control system the status of the sealing element from the status monitoring system of the sealing element for verifying the correct installation of the sealing element on the container. The method comprises the step of the local operator, with the approval of the remote operator, disconnecting the leash element from the sealing element and putting the leash element in the first storage compartment. The method comprises the step of the remote operator closing the first storage compartment by means of the remote control unit. These steps are performed while the remote operator observes the steps performed by the local operator via the video surveillance system. These steps are performed while the remote operator monitors the integrity of the leash element via the remote control unit and the control system.

The present invention further provides a method for unsealing a container using the tamper prevention system according to the embodiment of the present invention comprising the video surveillance system. The sealing element is installed on the container. No sealing element is stored in a closed first storage compartment of the storage unit. The method comprises the step of a local operator positioning the container in the field of view of the video surveillance system. The method comprises the step of a remote operator opening the first storage compartment by means of the remote control unit. The method comprises the step of the local operator taking the leash element out of the first storage compartment. The method comprises the step of the local operator connecting the leash element to the sealing element on the container. The method comprises the step of the local operator removing the sealing element from the container. The method comprises the step of the local operator storing the sealing element in the first storage compartment together with the leash element connected to the sealing element. The method comprises the step of the remote operator closing the first storage compartment by means of the remote control unit. The method comprises the step of the remote operator retrieving via the remote control unit and the control system the status of the sealing element from the status monitoring system of the sealing element. These steps are performed while the remote operator observes the steps performed by the local operator via the video surveillance system. These steps are performed while the remote operator monitors the integrity of the leash element via the remote control unit and the control system.

### BRIEF DESCRIPTION OF THE DRAWINGS

The invention will be further elucidated by means of the following description and the appended figures.

FIG. 1 shows a schematic representation of a storage unit of a tamper prevention system according to an embodiment of the present invention.

FIG. 2 shows a schematic representation of a tamper prevention system according to an embodiment of the present invention.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

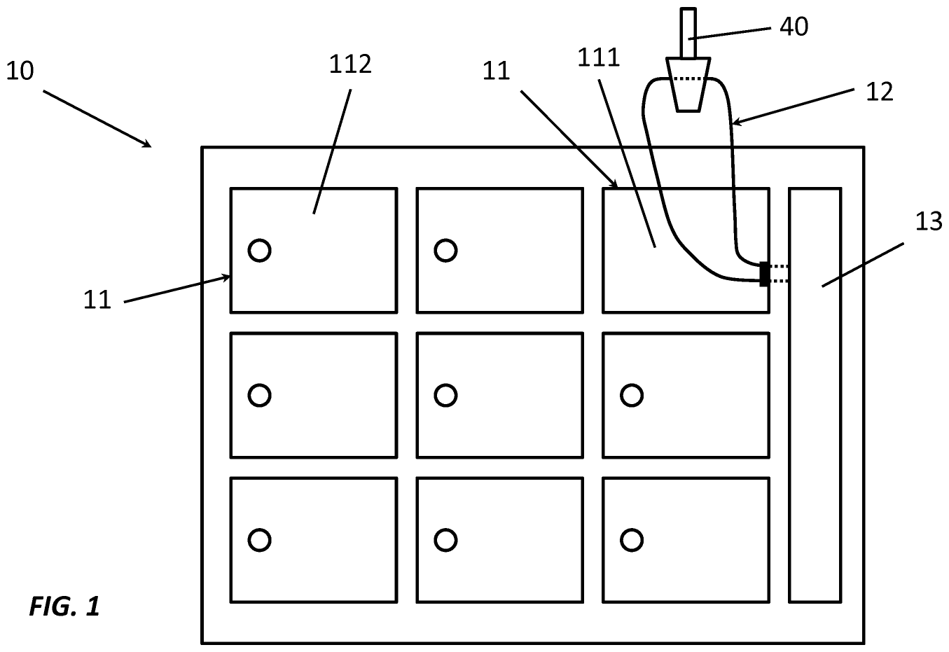

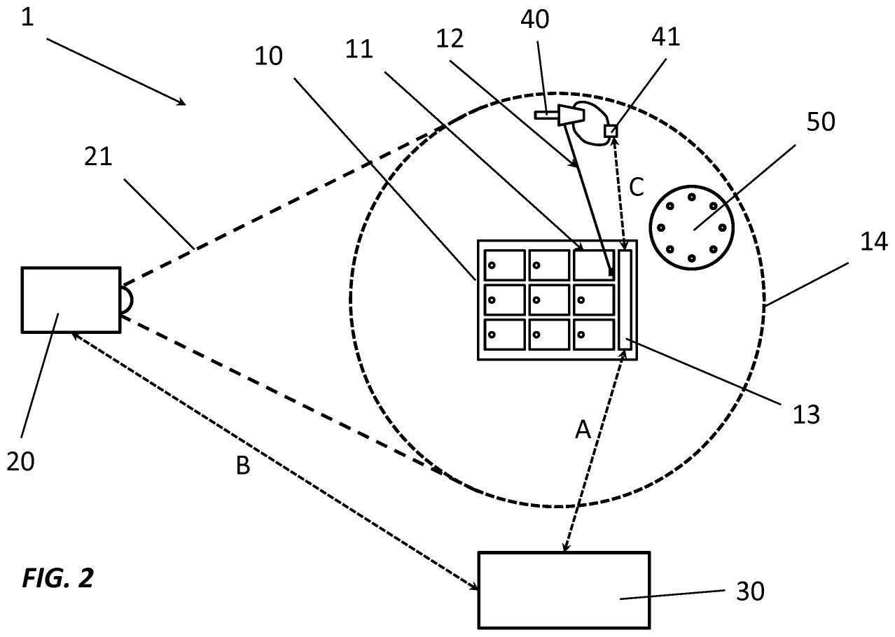

FIG. 1 shows a schematic representation of a storage unit 10 of a tamper prevention system 1 according to an embodiment of the present invention. In a further embodiment of the tamper prevention system 1 the storage unit 10 is used in combination with a video surveillance system 20 for observing the storage unit, a remote control unit 30 for remotely operating and monitoring the storage unit 10, and at least one sealing element 40, such as shown in FIG. 2.

The storage unit 10 comprises a plurality of storage compartments 11 for storing sealing elements 40 for containers 50, such as for example a sealing bolt as described in EP 3 206 211 A1. The storage compartment 11 comprises an enclosure 111 in which the sealing element 40 is to be positioned for storing it in the storage compartment 11. The storage compartment 11 comprises a door 112 for opening and closing of the enclosure 111 of the storage compartment 11. The storage compartment 11 may further be provided with a door operating unit which enables the door 112 to be opened and closed remotely. The storage compartment 11 may further be provided with a door locking unit provided for locking the door 112 in the closed state, and for unlocking the door 112 when locked in the closed state.

The storage unit 10 also comprises a control system 13 which is configured for detecting when the storage compartments 11 of the storage unit 10 are being opened, such that unauthorised opening of the storage compartment 11 can be detected and prevented. The detection of the opening of a storage compartment 11 may for example be done by changing the pressure in the closed enclosure 111 of the storage compartment 11 with respect to the atmospheric pressure in the environment of the storage unit 10 and by monitoring pressure changes caused by opening the enclosure of the storage compartment 11, similar to the tamper prevention system described in EP 3 205 996 A1. But this may for example also be done by monitoring the status of a door operating unit or a door locking unit of the storage compartments 11 of the storage unit 10.

Each storage compartment 11 of the storage unit 10 comprises a leash element 12 which is connected at the inside of the enclosure 111 to the control system 13 of the storage unit 10. For connecting the leash element 12 to the control system 13, the leash element 12 may be passed through an opening in a side wall of the enclosure 111 and connected directly to the control system 13. There may also be provided one or more connectors at the inside of the enclosure 111 of the storage compartment 11, to which connectors the leash element 12 can be connected, and from which connectors further connections are provided to the control system 13 inside of the storage unit 10.

The leash element 12 is provided for being connected to a sealing element 40 to be stored in the storage compartment 11. The leash element 12 may be a longitudinal element which is connected at a first end to the control system 13 from the inside of the enclosure 111, and provided at a second end for being connected to a sealing element 40. The leash element 12 may also be a longitudinal element which is connected at both a first end and a second end to the control system 13 from the inside of the enclosure 111, thereby forming a loop. In this configuration the leash element 12 may be connected to a sealing element 40 by passing the leash element 12 through an opening in the sealing element 40, which opening may be provided in the sealing element 40 especially for this purpose.

The leash element 12 has a predetermined length, such that a sealing element 40, when connected to the leash element 12, cannot be moved outside of a predetermined region 14 around the storage unit 10, such as shown in FIG. 2. This prevents the sealing element 40 from being moved outside the field of view 21 of a video surveillance system 20 monitoring the storage unit 10, where the sealing element 40 may be tampered with.

The control system 13 of the storage unit 10 is provided for monitoring the integrity of the leash element 12. Therefore, the leash element 12 may comprise a longitudinal conductor. The control system 13 then comprises a transmitter connected to a first end of the conductor. The transmitter is configured for transmitting a signal through the conductor. The control system 13 also comprises a detector connected to a second end of the conductor. The detector is configured for detecting the signal transmitted through the conductor by the transmitter. The control system 13 is then able to monitor the integrity of the leash element 12 based on the modification of the signal transmitted through the conductor from the transmitter to the detector.

The conductor may be an optical fibre, in which case the transmitter and detector are respectively an optical transmitter and an optical detector. The control system 13 is then able to monitor the integrity of the leash element 12 based on the modification of an optical signal passing through the optical fibre. The monitored property of the optical signal may e.g. be its light intensity.

The conductor may also be an electrical cable, in which case the transmitter and detector are respectively an electrical transmitter and an electrical detector. The control system 13 is then able to monitor the integrity of the leash element 12 based on the modification of an electrical signal passing through the electrical cable. The monitored property of the electrical signal may e.g. be its voltage or current.

The tamper prevention system 1 is also provided with movement protection means (not shown). These movement protection means are configured for detecting and/or preventing the movement of the storage unit 10, such that the storage unit 10 cannot be moved outside of the field of view of a video surveillance system 20 with which the storage unit is being observed, or at least not without being detected. This prevents tampering with sealing elements 40 stored in the storage unit 10 outside the field of view 21 of the video surveillance system 20.

The movement protection means may be fixing means by means of which the storage unit 10 is attached to a surface, such as for example a wall or a floor. The fixing means may for example be the combination of bolt openings provided on the storage unit 10 and bolts by means of which the storage unit 10 can be screwed against a surface. Movement protections means for preventing the movement of the storage unit 10 may also be realised by embedding the storage unit 10 in a surface, such as for example a wall or a floor. The movement protection means may also be a large weight integrated in the storage unit 10, which makes it very difficult to move the storage unit 10. Movement protection means for detecting the motion of the storage unit 10 may for example be implemented by means of optical trackers on the storage unit of which the movement is monitored via a video surveillance system 20 or other imaging system.

The tamper prevention system 1 according an embodiment of the present invention may be used in the set-up shown in FIG. 2. Here, the tamper prevention system 1 comprises a storage unit 10 for sealing elements 40 for containers 50, a video surveillance system 20 for monitoring the storage unit, a remote control unit for remotely operating and monitoring the storage unit 10, and one or more sealing elements 40 for containers 50.

The storage unit 10 comprises a plurality of storage compartments 11 for storing sealing elements 40. The storage unit 10 comprises at least a door locking unit provided for locking the doors 112 of the storage compartments 11 in the closed state, and for unlocking the door 112 when locked in the closed state. The control system 13 of the storage unit 10 is configured for communication with the remote control unit 30 (arrow A), such that the doors 112 of the storage compartments 11 can be locked and unlocked remotely by a remote operator, such as an inspector, by means of the remote control unit 30. The control system 13 of the storage unit 10 is also provided for communication with the remote control unit 30 to enable a remote operator to remotely monitor the integrity of the leash elements 12 of the storage compartments 11 and to detect the opening of the storage compartments 11 by means of the remote control unit 30.

The video surveillance system 20 comprises a camera in a secured housing to prevent tampering with the camera. The video surveillance system 20 is also provided for communication with the remote control unit 30 (arrow B), to enable a remote operator, such as an inspector, to view the images of the camera and to remotely control the camera.

The sealing element 40 comprise a status monitoring system 41 for monitoring the status of the sealing element 40, such as for example the monitoring and detection unit of the sealing bolt of EP 3 206 211 A1. The status of the sealing element 40 being monitored comprises an identifier of the sealing element 40, information about the installation of the sealing element 40 on a container 50 and information about the integrity of the sealing element 40.

The control system 13 of the storage unit 10 is configured for communication with the status monitoring systems 41 of the sealing elements 40 (arrow C) and with the remote control unit 30 to enable a remote operator to monitor the status of the sealing elements 40 by means of the remote control unit 30.

The storage unit 10 is located at a predetermined position in a room or space where containers 50 are to be sealed by a local operator. The storage unit 10 is fixed at that position by means of the movement protection means. Because the leash elements 12 of the storage compartments 11 have a predetermined fixed length, sealing elements 40 connected the leash elements 12, cannot be moved outside of a predetermined region 14 around the storage unit 10. The camera of the video surveillance system 20 is positioned and oriented in such a way that the storage unit 10 and the predetermined region 14 around the storage unit 10, defined by the predetermined length of the leash elements 12 of the storage compartments 11 of the storage unit 10, falls within the field of view of the camera. In this way, sealing elements 40 connected to the leash elements 12 cannot be moved outside of the field of view 21 of the camera. Preferably, the position and orientation of the video surveillance system 20 is fixed in this way.

The tamper prevention system 1 according to such an embodiment of the present invention may be used for sealing containers 50, such as dry storage casks for nuclear spent fuel, as follows.

The storage compartments 11 of the storage unit 10 are initially filled by an inspector with sealing elements 40, such as the sealing bolts of EP 3 206 211 A1, when the inspector is at the location where the containers 50 are to be sealed by local operators. In the storage compartment 11 each sealing element 40 is connected to the leash element 12 of the storage compartment 11. Then, the doors 112 of the storage compartments 11 are closed and locked by the inspector. These steps put the storage unit 10 in an initial state which allows the inspector to remotely monitor, via the remote control unit 30 and via the video surveillance system 20, the process of sealing the containers 50 by a local operator.

To start the sealing of a container 50, the local operator first positions the container 50 within the field of view 21 of the video surveillance system 20, and thus within the predetermined region 14 around the storage unit 10.

Then, the inspector, as a remote operator at the remote control unit 30, unlocks the door of one of the storage compartments 11 of the storage unit 10 by means of the remote control unit 30, such that the storage compartment 11 can be opened.

Then, the local operator takes the sealing element 40 located in the opened storage compartment 11 out of said storage compartment 11 with the leash element 12 still connected to the sealing element 40 such that the sealing element 40 cannot be moved outside of the field of view 21 of the video surveillance system 20. During this step, the inspector can check the status of the sealing element 40 via the remote control unit 30 and the status monitoring system 41 of the sealing element 40. This allows the inspector to check whether the sealing element 40 taken out of the opened storage compartment 11 is indeed the sealing element 40 which was originally stored in the storage compartment 11 by the inspector, and if the integrity of the sealing element 40 has not been compromised.

The local operator then installs the sealing element 40 which has been taken out of the opened storage compartment 11 on the container 50 in the field of view 21 of the video surveillance system 20. After this step, the inspector checks the status of the sealing element 40 to check if the sealing element 40 has been installed correctly on the container 50.

After the inspector has verified the correct installation of the sealing element 40, the local operator disconnects the leash element 12 from the sealing element 40. With the storage unit 10 of FIG. 1, the leash element 12 is disconnected from the sealing element 40, by disconnecting one end of the leash element 12 inside the storage compartment 11, passing the disconnected end of the leash element through the sealing element 40 for taking the leash element 12 out of the sealing element 40. After that the leash element 12 has been disconnected, the local operator puts the leash element 12 back in the opened storage compartment 11. The door 112 of the opened storage compartment 11 is then closed, and the inspector locks the door 112 of said storage compartment 11 by means of the remote control unit 30 and the door locking unit.

These steps are performed while the inspector observes the steps performed by the local operator via the video surveillance system 20. During these steps the inspector also monitors the integrity of the leash element 12 via the remote control unit 30 and the control system 13 to detect unauthorised cutting or disconnecting of the leash element 12 before the sealing element 40 has been correctly installed on the container 50.

These steps may be repeated multiple times for different storage compartments 11 and sealing elements 40, in order to install the required amount of sealing elements 40 on the container 50 in order to seal the container 50.

The tamper prevention system 1 according to such an embodiment of the present invention may also be used for unsealing containers 50 which have been sealed before by one or more sealing elements 40 according to the method described above.

In an initial state at least one of the storage compartments 11 of the storage unit 10 is empty, meaning that no sealing element 40 is stored therein. The leash element 12 of the empty storage compartments 11 is located in the enclosure 111 of the storage compartment 11, and the door 112 of the storage compartment 11 is locked in the closed position by means of the door locking unit of the storage unit 10.

To start the unsealing of the container 50, the local operator first positions the container 50 within the field of view 21 of the video surveillance system 20, and thus within the predetermined region 14 around the storage unit 10.

Then, the inspector unlocks the door 112 of an empty storage compartment 11 of the storage unit 10 by means of the remote control unit 30, such that the storage compartment 11 can be opened.

In the next steps, the local operator first takes the leash element 12 out of the opened storage compartment 11 and then connects said leash element 12 to a sealing element 40 on the container 50. With the storage unit 10 of FIG. 1, the leash element 12 is connected to the sealing element 40, by disconnecting one end of the leash element 12 inside the storage compartment 11, passing the disconnected end of the leash element through the sealing element 40, and reconnecting the disconnected end inside the storage compartment 11.

With the leash element 12 connected to the sealing element 40, the local operator then removes the sealing element 40 from the container 50 for unsealing the container 50, and puts the removed sealing element 40 in the opened storage compartment 11 together with the leash element 12. The door 112 of the opened storage compartment 11 is then closed, and the inspector locks the door 112 of said storage compartment 11 by means of the remote control unit 30 and the door locking unit.

After this step, the inspector checks the status of the sealing element 40 via the remote control unit 30 and the status monitoring system 41 of the sealing element 40. This allows the inspector to check whether the sealing element 40 removed from container 50 is indeed one of the sealing elements 40 which was originally installed on the container 50 during the process of sealing the container 50 as described above. This also allows the inspector to check whether the integrity of the sealing element 40 has not been compromised before removal from the container 50.

These steps are performed while the inspector observes the steps performed by the local operator via the video surveillance system 20. During these steps the inspector also monitors the integrity of the leash element 12 via the remote control unit 30 and the control system 13 to detect unauthorised cutting or disconnecting of the leash element 12 while the sealing element 40 is being removed from the container 50 and stored in the opened storage compartment 11 of the storage unit 10.

These steps may be repeated multiple times for different storage compartments 11 and sealing elements 40 until all of the sealing elements 40 have been removed from the container 50.

Finally, if at a later moment in time, the inspector is physically present at the storage unit 10, the inspector can then check whether the leash elements 12 have been correctly connected to the sealing elements 40, in order to verify that the sealing elements 40 seen on the video surveillance system 20 were put on right container 50.

### REFERENCES

1 tamper prevention system
10 storage unit
11 storage compartment
111 enclosure
112 door
12 leash element
13 control system
14 predetermined region
20 video surveillance system
21 field of view
30 remote control unit
40 sealing element
41 status monitoring system
50 container

1. A tamper prevention system comprising a storage unit, wherein the storage unit comprises:
at least one storage compartment for storing a sealing element for containers, wherein the at least one storage compartment is arranged for being opened and closed; and
a control system configured for detecting opening of the at least one storage compartment;
wherein each storage compartment comprises a leash element, wherein the leash element is connected to the control system and connectable to a sealing element to be stored in the storage compartment, wherein the control system is configured for monitoring the integrity of the leash element;
movement protection means configured for detecting and/or preventing movement of the storage unit;
a remote control unit configured to operate and monitor the storage unit, wherein the storage unit is configured for being remotely operated to at least enable remote opening and closing of the at least one storage compartment, and the control system is configured for communication with the remote control unit, and
a video surveillance system positioned and oriented such that the storage unit is located within a field of view of the video surveillance system, and such that the leash element of each storage compartment can only be moved within the field of view of the video surveillance system; and
a sealing element for containers, the sealing element comprising a status monitoring system for monitoring the status of the sealing element.

2. The tamper prevention system according to claim 1, wherein the storage unit is fixed at a predetermined position by the movement protection means.

3. The tamper prevention system according to claim 1, wherein the leash element has a predetermined length for limiting the movement of the sealing element, when connected to the leash element, within a predetermined region around the storage unit.

4. The tamper prevention system according to claim 1, wherein the leash element comprises a conductor, wherein the control system comprises a transmitter connected to a first end of the conductor and a detector connected to a second end of the conductor, and wherein the control system is configured for monitoring the integrity of the leash element based on the modification of a signal transmitted through the conductor from the transmitter to the detector.

5. The tamper prevention system according to claim 4, wherein the conductor comprises an optical fibre, wherein the transmitter comprises an optical transmitter, wherein the detector comprises an optical detector, and wherein the signal transmitted through the optical fibre is an optical signal.

6. The tamper prevention system according to claim 1, wherein the control system is configured for communication with a status monitoring system of a sealing element to be stored in the at least one storage compartment.

7. The tamper prevention system according to claim 1, wherein the control system is configured for secure communication.

8. The tamper prevention system according to claim 1, wherein the movement protection means comprises fixing means for fixing the storage unit to a surface.

9. A method for sealing a container using the tamper prevention system, wherein a sealing element is stored in a closed first storage compartment of a storage unit, wherein the sealing element is connected to a leash element of the first storage compartment, wherein the method comprises:
a local operator positioning the container in the field of view of a video surveillance system;
a remote operator opening the first storage compartment by a remote control unit;
the local operator taking the sealing element out of the first storage compartment;
the local operator sealing the container by installing the sealing element on the container;
the remote operator retrieving via the remote control unit and a control system the status of the sealing element from status monitoring system associated with the sealing element for verifying the correct installation of the sealing element on the container;
the local operator disconnecting the leash element from the sealing element and putting the leash element in the first storage compartment; and
the remote operator closing the first storage compartment by the remote control unit, and
wherein the steps are performed while the remote operator observes the steps performed by the local operator via the video surveillance system, and while the remote operator monitors the integrity of the leash element via the remote control unit and the control system.

10. A method for unsealing a container using a tamper prevention system, wherein a sealing element is installed on the container, wherein no sealing element is stored in a closed first storage compartment of a storage unit, wherein the method comprises:
a local operator positioning the container in a field of view of a video surveillance system;
a remote operator opening the first storage compartment by a remote control unit;
the local operator taking a leash element out of the first storage compartment;
the local operator connecting the leash element to the sealing element on the container;
the local operator removing the sealing element from the container;
the local operator storing the sealing element in the first storage compartment together with the leash element connected to the sealing element;
the remote operator closing the first storage compartment by the remote control unit; and
the remote operator retrieving via the remote control unit and a control system the status of the sealing element from a status monitoring system associated with the sealing element, and
wherein the steps are performed while the remote operator observes the steps performed by the local operator via the video surveillance system, and while the remote operator monitors the integrity of the leash element via the remote control unit and the control system.
